(19) United States
(12) Patent Application Publication
(10) Pub. No.: US 2017/0109113 A1
(43) Pub. Date: Apr. 20, 2017

(54) Remote Image Projection Method, Sever And Client Device

(71) Applicant: Tencent Technology (Shenzhen) Company Limited, Shenzhen (CN)

(72) Inventors: Ying HUANG, Shenzhen (CN); Yanqing JING, Shenzhen (CN); Jun LI, Shenzhen (CN); Wensheng CAO, Shenzhen (CN); Kang DU, Shenzhen (CN); Tianping GENG, Shenzhen (CN); Shaosheng ZHOU, Shenzhen (CN); Fan YANG, Shenzhen (CN)

(73) Assignee: Tencent Technology (Shenzhen) Company Limited, Shenzhen (CN)

(21) Appl. No.: 15/391,318

(22) Filed: Dec. 27, 2016

Related U.S. Application Data
(63) Continuation of application No. PCT/CN2015/092613, filed on Oct. 23, 2015.

(30) Foreign Application Priority Data
Oct. 31, 2014 (CN) 201410606094.7

(51) Int. Cl. G06F 3/14; H04L 29/06

(52) U.S. Cl. CPC G06F 3/14; H04L 67/42; G06T 2200/16; G06T 2210/08

(57) ABSTRACT

A remote image projection method, server and client are provided. The remote image projection method includes: obtaining, by a server, N rendering instructions invoked by a local application, wherein the N is a positive integer; determining, by the server, a rendering resource for executing the N rendering instructions; generating, by the server, a rendering sequence based on an execution sequence of the N rendering instructions executed by the local application, wherein the rendering sequence includes rendering instruction determination information for determining the N rendering instructions; and transmitting, by the server, to a client device the rendering sequence and rendering resource determination information for determining the rendering resource.

The present application is a continuation of International Application No. PCT/CN2015/092613, filed on Oct. 23, 2015, which claims priority to Chinese Patent Application No. 201410606094.7, titled “REMOTE IMAGE PROJECTION METHOD AND RELATED DEVICE”, filed on Oct. 31, 2014 with the State Intellectual Property Office of the People's Republic of China, both of which are incorporated by reference in their entireties herein.

### TECHNICAL FIELD

The present disclosure relates to the field of image processing technology, and in particular, to a remote image projection method, a server and a client device.

### BACKGROUND

In remote image projection technology, a remote client is used to display an image to be displayed or being displayed by a server, so as to facilitate a remote user to view the image to be displayed or being displayed by the server via the client device.

For example, in some scenarios such as a cloud service (such as cloud game or special effects production based on cloud), an image (such as a game image or an image with special effects) usually needs to be displayed on a remote client, to facilitate a remote user to view the image via the remote client. For example, a user make a special effects video with a sound effect application in a mobile phone, and wants to display the special effects video on a remote computer or smart television to facilitate the user himself or other people to examine the effect of the special effects video better. In this scenario, the mobile phone may be considered as a server (i.e., a remote projecting end), and the computer or the smart television may be considered as a client device (i.e., a remote projected end).

### SUMMARY

A remote image projection method, a server and a client are provided according to embodiments of the present disclosure, so as to reduce a network bandwidth occupied by remote image projection and improve the user experience.

A remote image projection method is provided according to an embodiment of the present disclosure, which includes:

obtaining, by a server, N rendering instructions invoked by a local application, where the N is a positive integer;

determining, by the server, a rendering resource for executing the N rendering instructions;

generating, by the server, a rendering sequence based on an execution sequence of the N rendering instructions executed by the local application, where the rendering sequence includes rendering instruction determination information for determining the N rendering instructions; and

transmitting, by the server, to a client device the rendering sequence and rendering resource determination information for determining the rendering resource.

Another remote image projection method is provided according to an embodiment of the present disclosure, which includes:

receiving, by a client device, a rendering sequence and rendering resource determination information from a server, where the rendering sequence includes rendering instruction determination information for determining N rendering instructions invoked by a local application of the server, the rendering resource determination information is for determining a rendering resource for executing the N rendering instructions, and the N is a positive integer; and

executing, by the client device, the N rendering instructions determined from the rendering sequence, and obtaining a rendered image by using the rendering resource.

A server is provided according to an embodiment of the present disclosure, which includes one or more processors and a storage medium storing operation instructions, where the processor executes the operation instructions in the storage medium to

obtain N rendering instructions invoked by a local application, where the N is a positive integer;

determine a rendering resource for executing the N rendering instructions;

generate a rendering sequence based on an execution sequence of the N rendering instructions executed by the local application, where the rendering sequence includes rendering instruction determination information for determining the N rendering instructions; and

transmit to a client device the rendering sequence and rendering resource determination information for determining the rendering resources.

A client device is provided according to an embodiment of the present disclosure, which includes one or more processors and a storage medium storing operation instructions, where the processors executes the operation instructions in the storage medium to

receive a rendering sequence and rendering resource determination information from a server, where the rendering sequence includes rendering instruction determination information for determining N rendering instructions invoked by a local application of the server, the rendering resource determination information is for determining a rendering resource for executing the N rendering instructions, and the N is a positive integer; and

execute the N rendering instructions determined from the rendering sequence, and obtain a rendered image by using the rendering resource.

### BRIEF DESCRIPTION OF THE DRAWINGS

FIG. 1 is a schematic flow chart of a remote image projection method according to an embodiment of the present disclosure;

FIG. 2 is a schematic flow chart of another remote image projection method according to an embodiment of the present disclosure;

FIG. 3-a is a schematic diagram of an architecture of a communication system according to an embodiment of the present disclosure;

FIG. 3-b is a schematic flow chart of another remote image projection method according to an embodiment of the present disclosure;

FIG. 4 is a schematic flow chart of another remote image projection method according to an embodiment of the present disclosure;

FIG. 5 is a schematic diagram of a server according to an embodiment of the present disclosure;

FIG. 6 is a schematic diagram of another server according to an embodiment of the present disclosure;

FIG. 7 is a schematic diagram of a client device according to an embodiment of the present disclosure; and

FIG. 8 is a schematic diagram of another client device according to an embodiment of the present disclosure.

### DETAILED DESCRIPTION OF EMBODIMENTS

In order to facilitate those skilled in the art to better understand the solutions in the present disclosure, the technical solutions in the embodiments of the present disclosure are described clearly and completely hereinafter in conjunction with the drawings in the embodiments of the present disclosure. Apparently, the described embodiments are only a few of the embodiments of the present disclosure. All other embodiments obtained by those ordinarily skilled in the art based on the embodiments of the present disclosure without any creative efforts fall within the protection scope of the present disclosure.

Terms such as “include”, “comprise” and any other variants thereof are meant to cover non-exclusive enclosure. For example, process, method, system, product or device including a series of steps or units is not limited to the listed steps or units, and optionally includes steps or units that are not listed or optionally includes other steps or units that are inherent in the process, method, product or device.

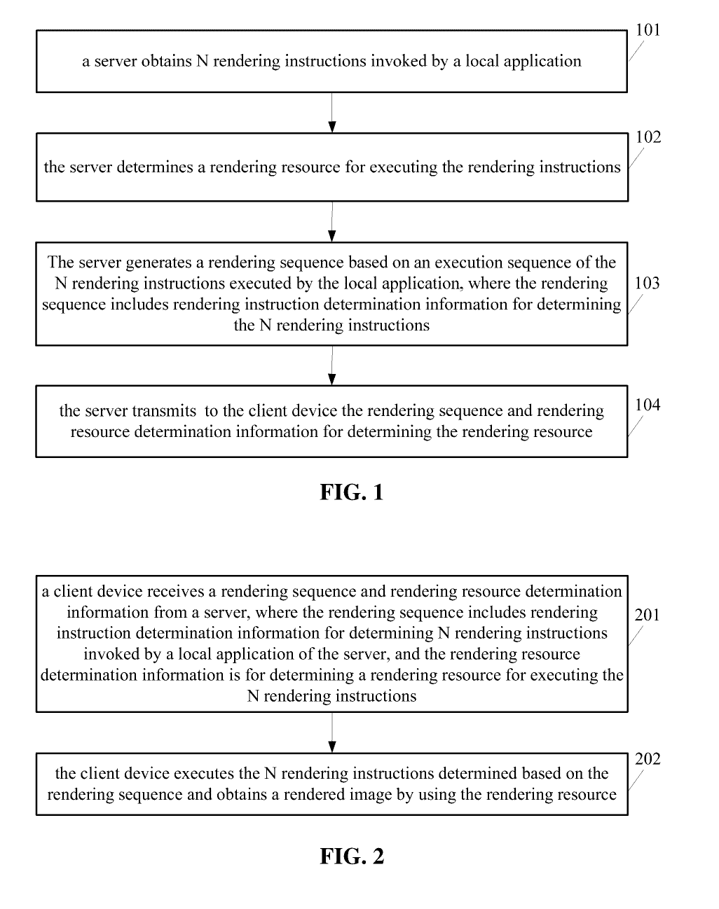

Reference is made to FIG. 1, which is a schematic flow chart of a remote image projection method according to an embodiment of the present disclosure. The method may be applied to a device such as a server. As shown in FIG. 1, the remote image projection method according to the embodiment of the present disclosure may include steps 101 to 104.

In step 101, a server obtains N rendering instructions invoked by a local application.

The N is a positive integer. For example, the N equals to 1, 2, 3, 4, 6, 21, 55 or other value. The local application may be any application that is operated in the server and is able to invoke rendering instructions.

The rendering instructions according to the embodiment of the present disclosure may be two-dimensional rendering instructions, three-dimensional rendering instructions or other type of rendering instructions.

In step 102, the server determines a rendering resource for executing the rendering instructions.

The rendering resource may include texture data, vertex data and/or a shader, etc.

In step 103, the server generates a rendering sequence based on an execution sequence of the N rendering instructions executed by the local application. The rendering sequence includes rendering instruction determination information for determining the N rendering instructions.

The server generates the rendering sequence based on the execution sequence of the N rendering instructions executed by the local application. Thus, the rendering sequence may indicate the execution sequence of the N rendering instructions, and the client device may determine the execution sequence of the N rendering instructions based on the rendering sequence.

In step 104, the server transmits to the client device the rendering sequence and rendering resource determination information for determining the rendering resource.

The server may transmit to the client a compressed rendering sequence and/or compressed rendering resource determination information for determining the rendering resources. Alternatively, the server may transmit to the client an uncompressed rendering sequence and/or uncompressed rendering resource determination information for determining the rendering resource.

In the technical solution according to the embodiment, the server transmits to the client device the rendering sequence including the rendering instruction determination information for determining the rendering instructions and the rendering resource determination information for determining the rendering resource, instead of transmitting a rendered image directly to the client device in a conventional manner. Since the rendering sequence and the rendering resource determination information usually have less data volume than the rendered image, the occupation of the network bandwidth may be decreased with the remote image projection solution according to the embodiment.

Further, image rendering operations may be performed by the client device rather than the server, and thus the processing resources of the client device may be utilized fully, the processing load of the server may be reduced. In this way, the server may support more client devices at the same time.

The server may be a game server, a cloud service server or other types of server.

Optionally, in some possible implementations of the present disclosure, the server may obtain the N rendering instructions invoked by the local application in the following manner. The server obtains the N rendering instructions invoked by the local application, by invoking a virtual image driver. The local application usually uses the virtual image deriver to invoke rendering instructions. Therefore, by operating the virtual image driver, the rendering instructions may not be actually executed by the server.

Optionally, in some possible implementations of the present disclosure, the server may also obtain the N rendering instructions invoked by the local application in the following manner. The server obtains the N rendering instructions invoked by the local application, by invoking instructions dynamically embedded into the local application.

Optionally, in some possible implementations of the present disclosure, the remote image projection method may further include: receiving, by the server, an image rendering feature supported by hardware of the client device from the client device. The server may obtain the N rendering instructions based on the feature supported by the hardware of the client device, where the N rendering instructions are invoked, based on the image rendering feature which is supported by the local application based on the hardware of the client device.

When the N rendering instructions are invoked by the local application of the server based on the image rendering feature (such as Caps feature) supported by the hardware of the client device, a hardware environment of the client device is simulated in the server to a certain extent. In this way, the rendering instructions invoked by the local application of the server may match the client device better, and thus the client device may obtain a better rendering effect.

If an image rendering feature supported by the hardware of the server is identical with or similar to that supported by the hardware of the client device, the client device may not transmit to the server the image rendering feature supported by the hardware of the client device, and the server may obtain the N rendering instructions invoked by the local application based on the image rendering feature supported by the hardware of the server.

Optionally, in some possible implementations of the present disclosure, the rendering instruction determination information for determining the N rendering instructions may include: the N rendering instructions or index identifiers of the N rendering instructions. It can be understood that the N rendering instructions may be determined based on the index identifiers of the N rendering instructions (such as addresses or names of the rendering instructions).

Optionally, in some possible implementations of the present disclosure, the rendering resource determination information for determining the rendering resource may include: the rendering resource or an index identifier of the rendering resource. It can be understood that the rendering resource may be determined based on the index identifier of the rendering resource (such as an address or a name of the rendering resource).

Reference is made to FIG. 2, which is a schematic flow chart of another remote image projection method according to an embodiment of the present disclosure. The method may be applied to a client device, such as a mobile phone, a personal computer or a tablet computer. As shown in FIG. 2, the remote image projection method according to the embodiment of the present disclosure may include steps 201 to 202.

In step 201, a client device receives a rendering sequence and rendering resource determination information from a server.

The rendering sequence includes rendering instruction determination information for determining N rendering instructions invoked by a local application of the server. The rendering resource determination information is used to determine a rendering resource for executing the N rendering instructions. The N is a positive integer. For example, the N may equal to 1, 2, 3, 4, 6, 21, 55 or other value. The local application may be any application that is operated in the server and is able to invoke the rendering instructions.

The rendering instructions according to the embodiment of the present disclosure may be two-dimensional rendering instructions, three-dimensional rendering instructions or other type of rendering instructions.

The rendering resource may include texture data, vertex data and/or a shader, etc.

The rendering sequence may be generated by the server based on an execution sequence of the N rendering instructions executed by the local application. When the server generates the rendering sequence based on the execution sequence of the N rendering instructions executed by the local application, the rendering sequence can indicate the execution sequence of the N rendering instructions, and the client device can determine the execution sequence of the N rendering instructions based on the rendering sequence.

The server may transmit to the client device a compressed rendering sequence and/or compressed rendering resource determination information for determining the rendering resource. Alternatively, the server may transmit to the client an uncompressed rendering sequence and/or uncompressed rendering resource determination information for determining the rendering resource.

Accordingly, the client device receives from the server the compressed or uncompressed rendering sequence, and the compressed or uncompressed rendering resource determination information.

In step 202, the client executes the N rendering instructions determined based on the rendering sequence, and obtains a rendered image by using the rendering resource determined from the rendering resource determination information.

Optionally, the client may also display the rendered image.

Optionally, in some possible implementations of the present disclosure, the server may obtain the N rendering instructions invoked by the local application, by invoking a virtual image driver. The local application usually invokes rendering instructions by using the virtual image deriver, and thus the rendering instructions is not actually executed in the server by operating the virtual image driver.

Optionally, in some possible implementations of the present disclosure, the server may obtain the N rendering instructions invoked by the local application, by invoking instructions dynamically embedded into the local application.

Optionally, in some possible implementations of the present disclosure, the remote image projection method may further include: transmitting, by the client device, to the server an image rendering feature supported by hardware of the client device.

Accordingly, the local application of the server may invoke the N rendering instructions based on the image rendering feature supported by the hardware of the client. The server may obtain the N rendering instructions which are invoked by the local application based on the image rendering feature supported by the hardware of the client device.

When the N rendering instructions are invoked by the local application of the server based on the image rendering feature (such as Caps feature) supported by the hardware of the client device, a hardware environment of the client device is simulated in the server to a certain extent. In this way, the rendering instructions invoked by the local application of the server may match the client device better and thus the client device may obtain a better rendering effect.

If an image rendering feature supported by the hardware of the server is identical with or similar to that supported by the hardware of the client device, the client device may not transmit to the server the image rendering feature supported by the hardware of the client device, and the server may obtain the N rendering instructions invoked by the local application based on the image rendering feature supported by the hardware of the server.

Optionally, in some possible implementations of the present disclosure, the rendering instruction determination information for determining the N rendering instructions may include: the N rendering instructions or index identifiers of the N rendering instructions. It can be understood that the N rendering instructions may be determined based on the index identifiers of the N rendering instructions (such as addresses or names of the rendering instructions).

Optionally, in some possible implementations of the present disclosure, the rendering resource determination information for determining the rendering resource may include: the rendering resource or an index identifier of the rendering resource. It can be understood that the rendering resource may be determined based on the index identifier of the rendering resource (such as an address or a name of the rendering resource).

For example, the server may be a game server, a cloud service server or other type of server.

In the technical solution according to the embodiment, the server transmits to the client the rendering sequence, including the rendering instruction determination information for determining the rendering instructions and the rendering resource determination information for determining the rendering resource, instead of transmitting rendered images directly to the client device in a conventional manner. Since the rendering sequence and the rendering resource determination information usually have less data volume than the rendered image, the occupation of the network bandwidth may be decreased with the remote image projection solution according to the embodiment.

Further, image rendering operations may be performed by the client device rather than the server, and thus the processing resources of the client device may be utilized fully, the processing load of the server may be reduced. In this way, the server may support more client devices at the same time.

In order to facilitate better understanding and better implementing the above technical solutions in the embodiments of the present disclosure, a further description is provided hereinafter in conjunction with some specific application scenarios.

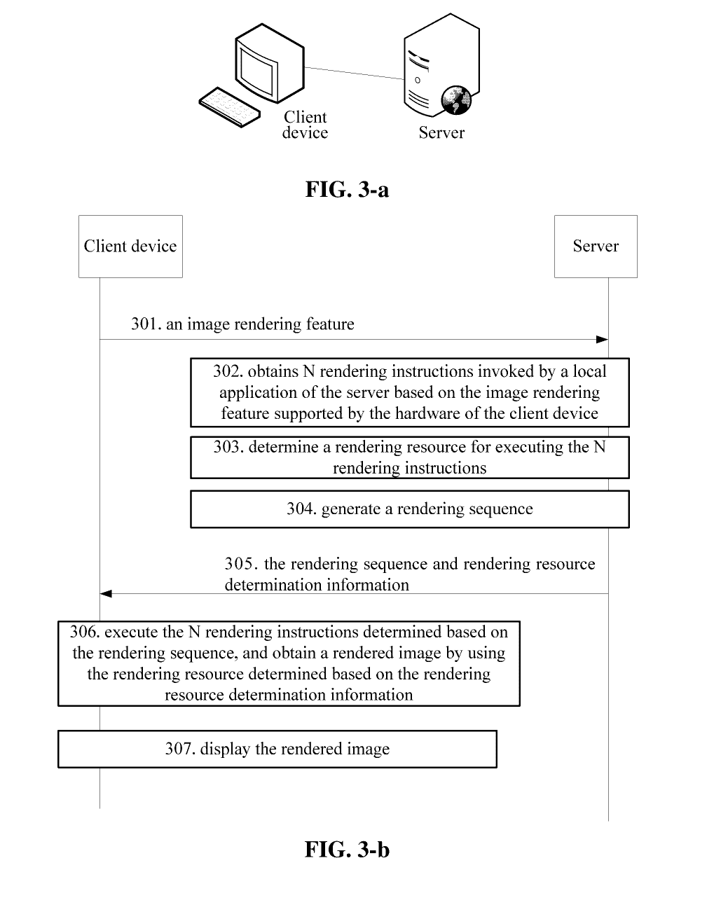

Referring to FIG. 3-a and FIG. 3-b, FIG. 3-b is a schematic flow chart of another remote image projection method according to an embodiment of the present disclosure. The remote image projection method shown in FIG. 3-b may be implemented based on a network architecture shown in FIG. 3-a. As shown in FIG. 3-b, the remote image projection method according to the embodiment of the present disclosure may include steps 301 to 307.

In step 301, a client device transmits to a server an image rendering feature supported by hardware of the client device.

The client device may initiate a transmission of the image rendering feature supported by the hardware of the client device to the server. Alternatively, the client device may transmit to the server the image rendering feature supported by the hardware of the client device based on a request of the server.

In step 302, the server receives from the client device the image rendering feature supported by the hardware of the client device. The server obtains N rendering instructions, where the N rendering instructions are invoked by a local application of the server based on the image rendering feature supported by the hardware of the client device.

The N is a positive integer. For example, the N equals to 1, 2, 3, 4, 6, 21, 55 or other value. The local application may be any application that is operated in the server and is able to invoke the rendering instructions.

The rendering instructions according to the embodiment of the present disclosure may be two-dimensional rendering instructions, three-dimensional rendering instructions or other type of rendering instructions.

When the N rendering instructions are invoked by the local application of the server based on the image rendering feature (such as Caps feature) supported by the hardware of the client device, a hardware environment of the client is simulated in the server to a certain extent. In this way, the rendering instructions invoked by the local application of the server may match the client device better, and then the client device may obtain a better rendering effect.

Optionally, in some possible implementations of the present disclosure, the server may obtain the N rendering instructions invoked by the local application thereof, by invoking a virtual image driver. The local application usually invokes rendering instructions by using the virtual image deriver. Therefore, by operating the virtual image driver, the rendering instructions may not be actually executed by the server.

Optionally, in some possible implementations of the present disclosure, the server may obtain the N rendering instructions invoked by the local application, by invoking instructions dynamically embedded into the local application.

In step 303, the server determines a rendering resource for executing the N rendering instructions.

The rendering resource may include texture data, vertex data and/or a shader, etc.

In step 304, the server generates a rendering sequence based on an execution sequence of the N rendering instructions executed by the local application. The rendering sequence includes rendering instruction determination information for determining the N rendering instructions.

The server generates the rendering sequence based on the execution sequence of the N rendering instructions executed by the local application. Thus, the rendering sequence may indicate the execution sequence of the N rendering instructions, and the client device may determine the execution sequence of the N rendering instructions based on the rendering sequence.

In step 305, the server transmits to the client the rendering sequence and rendering resource determination information for determining the rendering resource.

The server may transmit to the client a compressed rendering sequence and/or compressed rendering resource determination information for determining the rendering resource. Alternatively, the server may transmit to the client an uncompressed rendering sequence and/or uncompressed rendering resource determination information for determining the rendering resource.

In step 306, the client device receives the rendering sequence and the rendering resource determination information from the server; executes the N rendering instructions which are determined based on the rendering sequence; and obtains a rendered image, by using the rendering resource determined based on the rendering resource determination information.

In step 307, the client displays the rendered image.

In the technical solution according to the embodiment, the server transmits to the client device the rendering sequence, including the rendering instruction determination information for determining the rendering instructions and the rendering resource determination information for determining the rendering resource, instead of transmitting a rendered image directly to the client device in a conventional manner. Since the rendering sequence and the rendering resource determination information usually have less data volume than the rendered image, the occupation of the network bandwidth may be decreased with the remote image projection solution according to the embodiment.

Further, image rendering operations may be performed by the client device rather than the server, and thus the processing resources of the client device may be utilized fully, the processing load of the server may be reduced. In this way, the server may support more client devices at the same time.

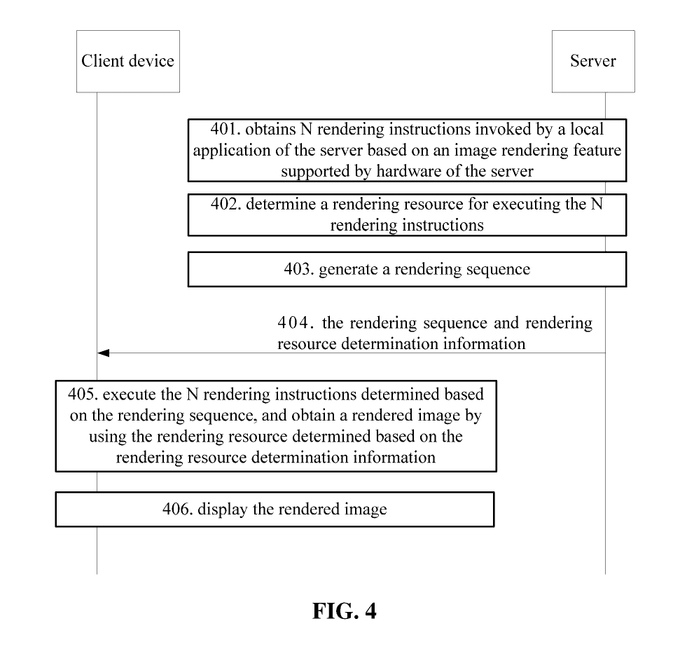

Reference is made to FIG. 4, which is a schematic flow chart of another remote image projection method according to an embodiment of the present disclosure. As shown in FIG. 4, the remote image projection method according to the embodiment of the present disclosure may include steps 401 to 406.

In step 401, a server obtains N rendering instructions, where the N rendering instructions are invoked by a local application of the server based on an image rendering feature supported by hardware of the server.

The N is a positive integer. For example, the N equals to 1, 2, 3, 4, 6, 21, 55 or other value. The local application may be any application that is operated in the server and is able to invoke rendering instructions.

The image rendering feature supported by the hardware of the server is identical with or similar to an image rendering feature supported by hardware of a client device.

The rendering instructions according to the embodiment of the present disclosure may be two-dimensional rendering instructions, three-dimensional rendering instructions or other type of rendering instructions.

Optionally, in some possible implementations of the present disclosure, the server may obtain the N rendering instructions invoked by the local application, by invoking a virtual image driver. The local application usually uses a virtual image deriver to invoke rendering instructions. Therefore, by operating the virtual image driver, the rendering instructions may not be actually executed in the server.

Optionally, in some possible implementations of the present disclosure, the server may obtain the N rendering instructions invoked by the local application, by invoking instructions dynamically embedded into the local application.

In step 402, the server determines a rendering resource for executing the N rendering instructions.

The rendering resource may include texture data, vertex data and/or a shader, etc.

In step 403, the server generates a rendering sequence based on an execution sequence of the N rendering instructions executed by the local application. The rendering sequence includes rendering instruction determination information for determining the N rendering instructions.

The server generates the rendering sequence based on the execution sequence of the N rendering instructions executed by the local application. Thus, the rendering sequence may indicate the execution sequence of the N rendering instructions, and the client device may determine the execution sequence of the N rendering instructions based on the rendering sequence.

In step 404, the server transmits to the client device the rendering sequence and rendering resource determination information for determining the rendering resource.

The server may transmit to the client device a compressed rendering sequence and/or compressed rendering resource determination information for determining the rendering resource. Alternatively, the server may transmit to the client device an uncompressed rendering sequence and/or uncompressed rendering resource determination information for determining the rendering resource.

In step 405, the client device receives the rendering sequence and the rendering resource determination information from the server; executes the N rendering instructions determined based on the rendering sequence; and obtains a rendered image, by using the rendering resource determined based on the rendering resource determination information.

In step 406, the client device displays the rendered image.

In the technical solution according to the embodiment, the server transmits to the client device the rendering sequence including the rendering instruction determination information for determining the rendering instructions and the rendering resource determination information for determining the rendering resource, instead of transmitting a rendered image directly to the client device in a conventional manner. Since the rendering sequence and the rendering resource determination information usually have less data volume than the rendered image, the occupation of the network bandwidth may be decreased with the remote image projection solution according to the embodiment.

It is found by test that in the technical solution according to the embodiment, a bandwidth occupied by a transmission between the server and the client device based on the solution of the present disclosure may have a maximum value of about 800K/b and a mean value of about 300K/b, which can meet the user's request for the bandwidth.

Further, image rendering operations may be performed by the client device rather than the server, and thus the processing resources of the client device may be utilized fully, the processing load of the server may be reduced. In this way, the server may support more client devices at the same time.

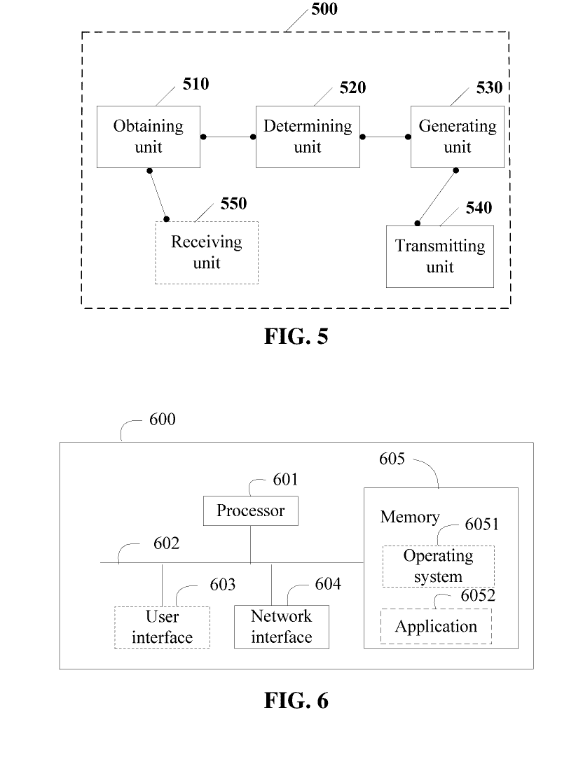

As shown in FIG. 5, a server 500 is further provided according to an embodiment of the present disclosure. The server 500 includes the following units.

An obtaining unit 510 is configured to obtain N rendering instructions invoked by a local application.

A determining unit 520 is configured to determine rendering resources for executing the N rendering instructions.

A generating unit 530 is configured to generate a rendering sequence based on an execution sequence of the N rendering instructions executed by the local application.

A transmitting unit 540 is configured to transmit to a client device the rendering sequence and rendering resource determination information for determining the rendering resources, where the N is a positive integer, and the rendering sequence includes rendering instruction determination information for determining the N rendering instructions.

Optionally, in some possible implementations of the present disclosure, the obtaining unit 510 may be configured to: obtain the N rendering instructions invoked by the local application, by invoking a virtual image driver; or obtain the N rendering instructions invoked by the local application, by invoking instructions dynamically embedded into the local application.

Optionally, in some possible implementations of the present disclosure, the server 500 may further include: a receiving unit 550, configured to receive from the client device an image rendering feature supported by hardware of the client device.

The obtaining unit 510 may be configured to: obtain the N rendering instructions, wherein the N rendering instructions are invoked by the local application based on the image rendering feature supported by the hardware of the client device.

Optionally, in some possible implementations of the present disclosure, the rendering instruction determination information for determining the N rendering instructions may include: the N rendering instructions or index identifiers of the N rendering instructions. It can be understood that the N rendering instructions may be determined based on the index identifiers of the N rendering instructions (such as addresses or names of the rendering instructions).

Optionally, in some possible implementations of the present disclosure, the rendering resource determination information for determining the rendering resource may include: the rendering resource or an index identifier of the rendering resource. It can be understood that the rendering resource may be determined based on the index identifier of the rendering resource (such as an address or a name of the rendering resource).

The server 500 may be a game server, a cloud service server or a server of other type.

It can be understood that, functions of various functional module in the server 500 according to the embodiment may be implemented based on the methods according to the above method embodiments. Specific implementations thereof may refer to related descriptions in the above method embodiments, which are not described herein.

In the technical solution according to the embodiment, the server transmits to the client device the rendering sequence including the rendering instruction determination information for determining the rendering instructions and the rendering resource determination information for determining the rendering resource, instead of transmitting a rendered image directly to the client device in a conventional manner. Since the rendering sequence and the rendering resource determination information usually have less data volume than the rendered image, the occupation of the network bandwidth may be decreased with the remote image projection solution according to the embodiment.

Further, image rendering operations may be performed by the client device rather than the server, and thus the processing resources of the client device may be utilized fully, the processing load of the server may be reduced. In this way, the server may support more client devices at the same time.

Reference is made to FIG. 6, which is a schematic diagram of a server 600 according to another embodiment of the present disclosure. The server 600 may include: at least one processor 601, a memory 605 and at least one communication bus 602. The communication bus 602 is configured to connect components to achieve a communication therebetween. The server 600 optionally includes a user interface 603 including a display (such as a touch screen, a liquid crystal display, a holographic imaging device or a projector), a click device (such as a mouse, a trackball, a touch panel or a touch screen), a camera and/or a sound capturing device.

The server 600 may further include at least one network interface 604.

The memory 605 may include a read-only memory and a random access memory, and provide instructions and data to the processor 601. A part of memory 605 may further include a non-volatile random access memory.

In some implementations, the memory 605 stores the following elements, to execute modules or data structures, subsets thereof or extended sets thereof.

An operating system 6051 includes various system programs for achieving various basic services and processing hardware-based tasks; and

An application module 6052 includes various applications for achieving various application services.

The application module 6052 includes, but is not limited to, a receiving unit 550, an obtaining unit 510, a determining unit 520, a generating unit 530 and/or a transmitting unit 540.

In the embodiment of the present disclosure, by invoking programs or instructions stored in the memory 605, the processor 601 obtains N rendering instructions invoked by a local application of a server; determines a rendering resource for executing the N rendering instructions; and generates a rendering sequence based on an execution sequence of the N rendering instruction executed by the local application, and transmits to a client device the rendering sequence and rendering resource determination information for determining the rendering resource, where the N is a positive integer, and the rendering sequence includes rendering instruction determination information for determining the N rendering instructions.

The N may equal to 1, 2, 3, 4, 6, 21, 55 or other value. The local application may be any application that is operated in the server and is able to invoke rendering instructions.

The rendering instructions according to the embodiment of the present disclosure may be two-dimensional rendering instructions, three-dimensional rendering instructions or other type of rendering instructions.

The rendering resource may include texture data, vertex data and/or a shader, etc.

The processor 601 may transmit to the client device a compressed rendering sequence and/or compressed rendering resource determination information for determining the rendering resource. Alternatively, the processor 601 may transmit to the client device an uncompressed rendering sequence and/or uncompressed rendering resource determination information for determining the rendering resource.

Optionally, in some possible implementations of the present disclosure, the processor 601 may be configured to obtain the N rendering instructions invoked by the local application of the server, by invoking a virtual image driver. The local application usually uses a virtual image deriver to invoke rendering instructions. Therefore, by operating the virtual image driver, the rendering instructions may not be actually executed in the server.

Optionally, in some possible implementations of the present disclosure, the processor 601 may be configured to obtain the N rendering instructions invoked by the local application of the server, by invoking instructions dynamically embedded into the local application of the server.

Optionally, in some possible implementations of the present disclosure, the processor 601 may be configured to receive from the client device an image rendering feature supported by hardware of the client device. The processor 601 may be configured to obtain the N rendering instructions, where the N rendering instructions are invoked by the local application of the server based on the image rendering feature supported by the hardware of the client device.

When the N rendering instructions are invoked by the local application of the server based on the image rendering feature (such as Caps feature) supported by the hardware of the client device, a hardware environment of the client device is simulated in the server to a certain extent. In this way, the rendering instructions invoked by the local application of the server may match the client device better and thus the client device may obtain a better rendering effect.

If an image rendering feature supported by the hardware of the server is identical with or similar to that supported by the hardware of the client device, the client device may not transmit to the server the image rendering feature supported by the hardware of the client device. The processor 601 may also obtain the N rendering instructions invoked by the local application of the server based on the image rendering feature supported by the hardware of the server.

Optionally, in some possible implementations of the present disclosure, the rendering instruction determination information for determining the N rendering instructions may include: the N rendering instructions or index identifiers of the N rendering instructions. It can be understood that the N rendering instructions may be determined based on the index identifiers of the N rendering instructions (such as addresses or names of the rendering instructions).

Optionally, in some possible implementations of the present disclosure, the rendering resource determination information for determining the rendering resource may include: the rendering resource or an index identifier of the rendering resource. It can be understood that the rendering resource may be determined based on the index identifier of the rendering resource (such as an address or a name of the rendering resource).

The server 600 may be may be a game server, a cloud service server or other type of server.

It can be understood that, functions of various functional module in the server 600 according to the embodiment may be implemented based on the methods according to the above method embodiments. Specific implementations thereof may refer to related descriptions in the above method embodiments, which are not described herein.

In the technical solution according to the embodiment, the server transmits to the client device the rendering sequence including the rendering instruction determination information for determining the rendering instructions and the rendering resource determination information for determining the rendering resource, instead of transmitting a rendered image directly to the client device in a conventional manner. Since the rendering sequence and the rendering resource determination information usually have less data volume than the rendered image, the occupation of the network bandwidth may be decreased with the remote image projection solution according to the embodiment.

Further, image rendering operations may be performed by the client device rather than the server, and thus the processing resources of the client device may be utilized fully, the processing load of the server may be reduced. In this way, the server may support more client devices at the same time.

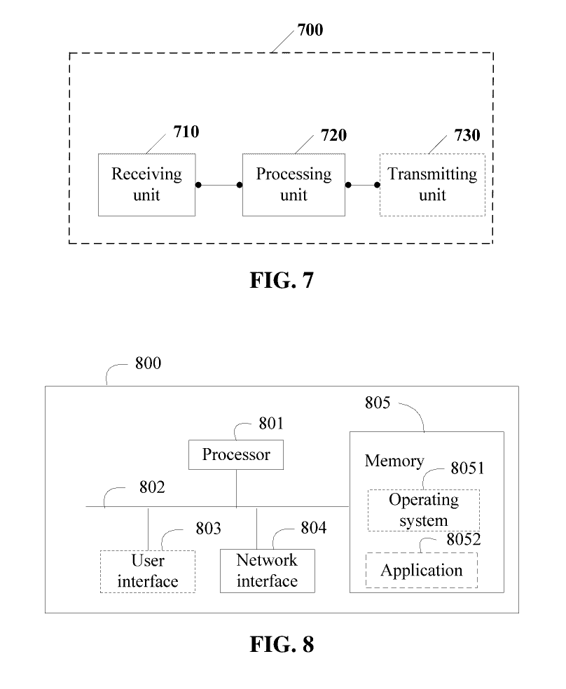

As shown in FIG. 7, a client device 700 is provided according to an embodiment of the present disclosure, which may include:

A receiving unit 710 is configured to receive a rendering sequence and rendering resource determination information from a server, where the rendering sequence includes rendering instruction determination information for determining N rendering instructions invoked by a local application of the server, the rendering resource determination information is used to determine a rendering resource for executing the N rendering instructions, and the N is a positive integer.

A processing unit 720 is configured to execute the N rendering instructions determined from the rendering sequence, and obtain a rendered image by using the rendering resource determined based on the rendering resource determination information.

Optionally, in some possible implementations of the present disclosure, the client device 700 further includes: a transmitting unit 730, configured to transmit to the server an image rendering feature supported by hardware of the client device.

Accordingly, the local application of the server may invoke the N rendering instructions based on the image rendering feature supported by the hardware of the client device. The server may obtain the N rendering instructions, where the N rendering instructions are invoked by the local application based on the image rendering feature supported by the hardware of the client device.

When the N rendering instructions are invoked by the local application of the server based on the image rendering feature (such as Caps feature) supported by the hardware of the client device, a hardware environment of the client device is simulated in the server to a certain extent. In this way, the rendering instructions invoked by the local application of the server may match the client device better; and thus the client device may obtain a better rendering effect.

The N is a positive integer. For example, the N may equal to 1, 2, 3, 4, 6, 21, 55 or other value. The local application may be any application that is operated in the server and is able to invoke the rendering instructions.

The rendering instructions according to the embodiment of the present disclosure may be two-dimensional rendering instructions, three-dimensional rendering instructions or other type of rendering instructions.

The rendering resource may include texture data, vertex data and/or a shader, etc.

The rendering sequence may be generated by the server based on an execution sequence of the N rendering instructions executed by the local application. When the server generates the rendering sequence based on the execution sequence of the N rendering instructions executed by the local application, the rendering sequence can indicate the execution sequence of the N rendering instructions, and the client device can determine the execution sequence of the N rendering instructions based on the rendering sequence.

The server may transmit to the client device a compressed rendering sequence and/or compressed rendering resource determination information for determining the rendering resource. Alternatively, the server may transmit to the client device an uncompressed rendering sequence and/or uncompressed rendering resource determination information for determining the rendering resource.

Accordingly, the receiving unit 710 may receive the compressed or uncompressed rendering sequence, and the compressed or uncompressed rendering resource determination information from the server.

Optionally, in some possible implementations of the present disclosure, the server may obtain the N rendering instructions invoked by the local application of the server, by invoking a virtual image driver. The local application usually uses a virtual image deriver to invoke rendering instructions. Therefore, by operating the virtual image driver, the rendering instructions may not be actually executed in the server.

Optionally, in some possible implementations of the present disclosure, the server may obtain the N rendering instructions invoked by the local application of the server, by invoking instructions dynamically embedded into the local application of the server.

Optionally, in some possible implementations of the present disclosure, the rendering instruction determination information for determining the N rendering instructions may include: the N rendering instructions or index identifiers of the N rendering instructions. It can be understood that the N rendering instructions may be determined based on the index identifiers of the N rendering instructions (such as addresses or names of the rendering instructions).

Optionally, in some possible implementations of the present disclosure, the rendering resource determination information for determining the rendering resource may include: the rendering resource or an index identifier of the rendering resource. It can be understood that the rendering resource may be determined based on the index identifier of the rendering resource (such as an address or a name of the rendering resource).

It can be understood that, functions of various functional module in the client 700 according to the embodiment may be implemented based on the methods according to the above method embodiments. Specific implementations thereof may refer to related descriptions in the above method embodiments, which are not described herein.

It can be understand that the server transmits to the client device the rendering sequence including the rendering instruction determination information for determining the rendering instructions and the rendering resource determination information for determining the rendering resource, instead of transmitting a rendered image directly to the client device in a conventional manner. Since the rendering sequence and the rendering resource determination information usually have less data volume than the rendered image, the occupation of the network bandwidth may be decreased with the remote image projection solution according to the embodiment.

Further, image rendering operations may be performed by the client device rather than the server, and thus the processing resources of the client device may be utilized fully, the processing load of the server may be reduced. In this way, the server may support more client devices at the same time.

Reference is made to FIG. 8, which is a structural block diagram of a client device 800 according to another embodiment of the present disclosure. The client device 800 may include: at least one processor 801, a memory 805 and at least one communication bus 802. The communication bus 802 is configured to connect the components to achieve a communication therebetween. The client device 800 optionally includes a user interface 803 including a display (such as a touch screen, a liquid crystal display, a holographic imaging device or a projector), a click device (such as a mouse, a trackball, a touch panel or a touch screen), a camera and/or a sound capturing device.

The client device 800 may further include at least one network interface 804.

The memory 805 may include a read-only memory and a random access memory and provide instructions and data to the processor 801. A part of the memory 805 may further include a non-volatile random access memory.

In some implementations, the memory 805 stores the following elements, to execute modules or data structures, subsets thereof or extended sets thereof.

An operating system 8051 includes various system programs for achieving various basic services and process hardware-based tasks.

An application module 8052 includes various applications for achieving various application services.

The application module 8052 includes but not limited to a transmitting unit 730, a receiving unit 710 and/or a processing unit 720.

In the embodiment of the present disclosure, by invoking programs or instructions stored in the memory 805, the processor 801 receives a rendering sequence and rendering resource determination information from a server, where the rendering sequence includes rendering instruction determination information for determining N rendering instructions invoked by a local application of the server, the rendering resource determination information is used to determine a rendering resource for executing the N rendering instructions, and the N is a positive integer; and executes the N rendering instructions determined from the rendering sequence, and obtains a rendered image by using the rendering resource determined from the rendering resource determination information.

The N may equal to 1, 2, 3, 4, 6, 21, 55 or other value. The local application may be any application that is operated in the server and is able to invoke rendering instructions.

The rendering instructions according to the embodiment of the present disclosure may be two-dimensional rendering instructions, three-dimensional rendering instructions or other type of rendering instructions.

The rendering resource may include texture data, vertex data and/or a shader, etc.

The rendering sequence may be generated by the server based on an execution sequence the N rendering instructions executed by the local application. When the server generates the rendering sequence based on the execution sequence of the N rendering instructions executed by the local application, the rendering sequence can indicate the execution sequence of the N rendering instructions, and the client device can determine the execution sequence of the N rendering instructions based on the rendering sequence.

The server may transmit to the client device a compressed rendering sequence and/or compressed rendering resource determination information for determining the rendering resource. Alternatively, the server may transmit to the client device an uncompressed rendering sequence and/or uncompressed rendering resource determination information for determining the rendering resource.

Accordingly, the processor 801 receives the compressed or uncompressed rendering sequence, and the compressed or uncompressed rendering resource determination information from the server.

Optionally, in some possible implementations of the present disclosure, the server may obtain the N rendering instructions invoked by the local application, by invoking a virtual image driver. The local application usually uses a virtual image deriver to invoke rendering instructions. Therefore, by operating the virtual image driver, the rendering instructions may not be actually executed in the server.

Optionally, in some possible implementations of the present disclosure, the server may obtain the N rendering instructions invoked by the local application, by invoking instructions dynamically embedded into the local application.

Optionally, in some possible implementations of the present disclosure, the processor 801 is further configured to transmit to the server an image rendering feature supported by hardware of the client device.

Accordingly, the local application of the server may invoke the N rendering instructions based on the image rendering feature supported by the hardware of the client device. The server may obtain the N rendering instructions invoked by the local application based on the image rendering feature supported by the hardware of the client device.

When the N rendering instructions are invoked by the local application of the server based on the image rendering feature (such as Caps feature) supported by the hardware of the client device, a hardware environment of the client device is simulated in the server to a certain extent. In this way, the rendering instructions invoked by the local application of the server may match the client device better, and thus the client device may obtain a better rendering effect.

Optionally, in some possible implementations of the present disclosure, the rendering instruction determination information for determining the N rendering instructions may include: the N rendering instructions or index identifiers of the N rendering instructions. It can be understood that the N rendering instructions may be determined based on the index identifiers of the N rendering instructions (such as addresses or names of the rendering instructions).

Optionally, in some possible implementations of the present disclosure, the rendering resource determination information for determining the rendering resource may include: the rendering resource or an index identifier of the rendering resource. It can be understood that the rendering resource may be determined based on the index identifier of the rendering resource (such as an address or a name of the rendering resource).

It can be understood that, functions of various functional module in the client device 800 according to the embodiment may be implemented based on the methods according to the above method embodiments. Specific implementations thereof may refer to related descriptions in the above method embodiments, which are not described herein.

In the technical solution according to the embodiment, the server transmits to the client device the rendering sequence including the rendering instruction determination information for determining the rendering instructions, and the rendering resource determination information for determining the rendering resource, instead of transmitting a rendered image directly to the client device in a conventional manner. Since the rendering sequence and the rendering resource determination information usually have less data volume than the rendered image, the occupation of the network bandwidth may be decreased with the remote image projection solution according to the embodiment.

Further, image rendering operations may be performed by the client device rather than the server, and thus the processing resources of the client device may be utilized fully, the processing load of the server may be reduced. In this way, the server may support more client devices at the same time.

A computer storage medium is further provided according to an embodiment of the present disclosure. The computer storage medium may store a program. The program includes some or all steps in the remote image projection method according to any one of the above method embodiments

It should be noted that the above method embodiments are expressed as a series of combinations of actions for simplicity. Those skilled in the art should know that, the present disclosure is not limited by the described sequence of the actions, since some steps may be performed in other sequences or may be performed at the same time according to the present disclosure. Moreover, those skilled in the art should know that the embodiments described in the specification are all preferred embodiments, and actions and modules that are involved are not necessary to the present disclosure.

In the above embodiments, descriptions of various embodiments have their own emphases. Reference can be made to related descriptions in other embodiments for a section which is not described in detail in an embodiment.

It should be understood that the disclosed devices according to some embodiments of the present disclosure may be implemented in other ways. For example, the device embodiments described above are illustrative only. For example, the units are divided merely in logical function, which may be divided by another way in actual implementation. For example, multiple units or components may be combined or integrated into another system, or some features may be ignored or not performed. In addition, the disclosed or discussed mutual coupling or direct coupling or communication connection may be an indirect coupling or communication connection through some interfaces, devices or units, which may be implemented in electronic or other forms.

The units described as separated components may or may not be physically separated. A component displayed as a unit may or may not be a physical unit, which may be located in one position or distributed on multiple network units. A part or all of components may be selected to achieve the object of solutions in the embodiments based on practical requirements.

In addition, the functional units in the embodiments of the present disclosure may be integrated into a process unit or physically separated, or two or more units may be integrated into a unit. The integrated unit described above may be implemented in hardware or in software functional unit.

If the integrated unit is implemented in software functional unit and is sold or used as a separate product, it may be stored in a computer readable storage medium. Based on this understanding, the essence of the technical solutions, some of the technical solutions which contribute to the conventional technology, or, all or part of the technical solutions of the present disclosure may be implemented in a form of a software product, and the computer software product is stored in a storage medium including several instructions to enable a computer device (which may be a personal computer, a server or a network device, etc.) to execute all or some of the steps in the methods according to the embodiments of the present disclosure. The storage medium may include a medium that can store program codes, such as a USB flash disk, a read-only memory (Read-Only Memory, ROM), a random access memory (Random Access Memory, RAM), a mobile hard disk, an optical disk or a magnetic disk.

As described above, the embodiments are only used to illustrate the technical solutions in the present disclosure, and the present disclosure is not limited hereto. Although the present disclosure is illustrated in detail with reference to the embodiments, those skilled in the art should understand that modifications to the technical solutions in the embodiments can be made, or equivalent substitutions to some of the technical features can be made, and the modifications or substitutions do not make the essence of corresponding technical solutions depart from the scope of the technical solutions in the embodiments of the present disclosure.

1. A remote image projection method, comprising:
obtaining, by a server, N rendering instructions invoked by a local application, wherein the N is a positive integer; determining, by the server, a rendering resource for executing the N rendering instructions;
generating, by the server, a rendering sequence based on an execution sequence of the N rendering instructions executed by the local application, wherein the rendering sequence includes rendering instruction determination information for determining the N rendering instructions; and
transmitting, by the server, to a client device the rendering sequence and rendering resource determination information for determining the rendering resource.

2. The method according to claim 1, wherein the obtaining, by a server, N rendering instructions invoked by a local application comprises: obtaining, by the server, the N rendering instructions invoked by the local application, by invoking a virtual image driver.

3. The method according to claim 1, wherein the obtaining, by a server, N rendering instructions invoked by a local application comprises: obtaining, by the server, the N rendering instructions invoked by the local application, by invoking instructions dynamically embedded into the local application.

4. The method according to claim 1, further comprising: receiving, by the server, from the client device an image rendering feature supported by hardware of the client device.

5. The method according to claim 4, wherein the obtaining, by a server, N rendering instructions invoked by a local application comprises: obtaining, by the server, the N rendering instructions, wherein the N rendering instructions are invoked by the local application based on the image rendering feature supported by the hardware of the client device.

6. The method according to claim 1, wherein the rendering instruction determination information is index identifiers of the N rendering instructions.

7. The method according to claim 1, wherein the rendering resource determination information is an index identifier of the rendering resource.

8. A remote image projection method, comprising:
receiving, by a client device, a rendering sequence and rendering resource determination information from a server, wherein the rendering sequence includes rendering instruction determination information for determining N rendering instructions invoked by a local application of the server, the rendering resource determination information is for determining a rendering resource for executing the N rendering instructions, and the N is a positive integer; and
executing, by the client device, the N rendering instructions determined based on the rendering sequence, and obtaining a rendered image by using the rendering resource.

9. The method according to claim 8, further comprising: transmitting, by the client device, to the server an image rendering feature supported by hardware of the client device.

10. A server, comprising one or more processors and a storage medium for storing operation instructions, wherein the processors execute the operation instructions in the storage medium to
obtain N rendering instructions invoked by a local application, wherein the N is a positive integer;
determine a rendering resource for executing the N rendering instructions;
generate a rendering sequence based on an execution sequence of the N rendering instructions executing by the local application, wherein the rendering sequence includes rendering instruction determination information for determining the N rendering instructions; and
transmit to a client device the rendering sequence and rendering resource determination information for determining the rendering resource.

11. The server according to claim 10, wherein when obtaining the N rendering instructions invoked by the local application, the server obtains the N rendering instructions invoked by the local application, by invoking a virtual image driver.

12. The server according to claim 10, wherein when obtaining the N rendering instructions invoked by the local application, the server obtains the N rendering instructions invoked by the local application, by invoking instructions dynamically embedded into the local application.

13. The server according to claim 10, wherein the processors execute the operation instructions to:
receive from the client device an image rendering feature supported by hardware of the client device.

14. The server according to claim 13, wherein when obtaining the N rendering instructions invoked the local application, the server obtains the N rendering instructions, wherein the N rendering instructions are invoked by the local application based on the image rendering feature supported by the hardware of the client device.

15. A client device, comprising one or more processors and a storage medium for storing operation instructions, wherein the processors execute the operating instructions in the storage medium to
receive a rendering sequence and rendering resource determination information from a server, wherein the rendering sequence includes rendering instruction determination information for determining N rendering instructions invoked by a local application of the server, the rendering resource determination information is for determining a rendering resource for executing the N rendering instructions, and the N is a positive integer; and
execute the N rendering instructions determined based on the rendering sequence, and obtain a rendered image by using the rendering resource.

16. The client according to claim 15, wherein the processors execute the operation instructions to:
transmit to the server an image rendering feature supported by hardware of the client device.
